(19) United States
(12) Patent Application Publication
(10) Pub. No.: US 2015/0036624 A1
(43) Pub. Date: Feb. 5, 2015

(54) BASE STATION APPARATUS AND WIRELESS COMMUNICATION SYSTEM

(71) Applicant: Hitachi, Ltd., Tokyo (JP)

(72) Inventors: Kenzaburo FUJISHIMA, Tokyo (JP); Masanori TAIRA, Tokyo (JP); Shigenori HAYASE, Tokyo (JP)

(73) Assignee: Hitachi, Ltd., Tokyo (JP)

(21) Appl. No.: 14/450,514

(22) Filed: Aug. 4, 2014

(30) Foreign Application Priority Data
Aug. 5, 2013 (JP) 2013-162374

(51) Int. Cl. H04W 72/04; H04L 29/08

(52) U.S. Cl. CPC H04W 72/044; H04L 69/322
USPC 370/329

(57) ABSTRACT

Provided is a base station apparatus including an upper layer processor and a lower layer processor. The upper layer processor: holds allocation rights information representing that a cell has a right to allocate a part of a wireless resource owned by the cell to a terminal belonging to the cell, and does not have a right to allocate a remaining part of the wireless resource; allocates the part of the wireless resource which the cell has the right to allocate out of the wireless resource owned by the cell to the terminal; and instructs the lower layer processor to carry out wireless signal processing for the communication to/from the terminal. The lower layer processor: carries out, in accordance with the instruction to carry out the wireless signal processing, the wireless signal processing for the communication to/from the terminal; and notifies the upper layer processor of a result thereof.

### CLAIM OF PRIORITY

The present application claims priority from Japanese patent application JP2013-162374 filed on Aug. 5, 2013, the content of which is hereby incorporated by reference into this application.

### BACKGROUND OF THE INVENTION

This invention relates to inter-cell cooperative processing to be carried out in a cellular system.

As the related art in this technical field, there is known JP 2010-220094 A. This publication discloses the following technology. In order to distribute a load imposed on a control apparatus relating to base station cooperative communication where a plurality of base stations cooperate with one another to communicate to/from mobile stations, respective cells are divided into cooperation areas and a non-cooperation area. Each of the base stations is set so that the cooperation area for which the base station is responsible as a master base station does not overlap. A base station cooperation part of each of the base stations is configured to: determine whether the mobile station is in the non-cooperation area or the cooperation area; allocate, out of wireless resources managed separately as a wireless resource for the non-cooperation area and a wireless resource for the cooperation area, depending on the area of the mobile station, the wireless resource for the non-cooperation area, or the wireless resource for the cooperation area for which the base station is responsible as the master base station; exchange wireless resource allocation information on the cooperation area among the base stations to cooperate with one another; determine, based on the exchanged information, implementability of base station cooperation communication in the cooperation area for which the base station is responsible as the master base station; and notify the base stations subject to the cooperation of the determination.

Moreover, in Okamawari, et al, “Resource management method for CoMP JT with X2 interface”, the 2012 General Conference of the Institute of Electronics, Information and Communication Engineers, B-5-100, March 2012, there is disclosed a resource management method based on an anchor type for carrying out, in order to implement inter-cell cooperative processing, transmission in cooperation with an arbitrary neighboring base station by using an inter-base station interface without carrying out clustering, which fixes combinations of cells cooperating with one another.

### SUMMARY OF THE INVENTION

This invention has an object to simultaneously achieve free determination of a combination of cells for cooperative processing, and restraining of a control overhead caused by the cooperative processing among cells, particularly a control overhead relating to real time cooperative processing in a wireless communication system having a large number of cells which can be divided in a space domain or a frequency domain such as a cellular system.

In the cellular system, a base station accommodating one or more cells is additionally installed as a mobile traffic increases, and a wireless transmission environment is changed by constructing buildings and the like. As a result, a communication service may be interrupted by the influence of a radio wave shielding or an inter-cell radio wave interference in an area where the communication has been possible. In order to solve the situation by means of the inter-cell cooperative processing, it is preferred not to limit the flexibility of a combination of cells cooperating for processing, but to enable free changing of a combination of cells by adapting to a wireless environment and a traffic environment.

Moreover, each of the cells in the cellular system prepares wireless time-division channels whose usage rights are shared by a plurality of terminals at an interval of milliseconds. To which terminal the time division channel is to be allocated, namely, allocation of a wireless resource needs to be determined in a certain period equal to or less than a millisecond. When inter-cell cooperation control high in calculation load and inter-cell communication load is added to the operation at every certain period, a device high in calculation performance as well as high in power consumption is necessary in order to finish a processing imposing a high load in the certain period. It is preferred to bring the overhead caused by the inter-cell cooperation control to as close to zero as possible in terms of at least an environmental load.

A wireless resource to be allocated to a terminal coupled to each of the cells is defined for each of the cells. When the inter-cell cooperative processing is not considered, the allocation right of the wireless resource defined for a certain cell is owned by the cell itself. On the other hand, when the inter-cell cooperative processing needs to be considered, it is necessary to allow a certain cell A to have a right to allocate a wireless resource of another cell B. When a plurality of cells need the same wireless resource of a certain cell, such an inter-cell adjustment that any one of cells is allowed to use the wireless resource and the other cells are not allowed to use the wireless resource is necessary in order to avoid collision among a plurality of requests to use the wireless resource. The inter-cell adjustment is the overhead caused by the inter-cell cooperation control described above.

In order to avoid the adjustment among cells, it is conceivable to distribute in advance allocation rights for resources of neighboring cells in a fixed manner to each of the cells. This method restricts flexibility of combinations of cells for the above-mentioned cooperative processing.

In order to solve the foregoing problem, there is provided a base station apparatus for communicating to/from a terminal, comprising: a first wireless access upper layer processor corresponding to a first cell for wireless communication; and a first wireless access lower layer processor corresponding to the first cell, wherein: the first wireless access upper layer processor is configured to: hold allocation rights information representing that the first cell has a right to allocate a part of a wireless resource owned by the first cell to a terminal belonging to the first cell, and does not have a right to allocate a remaining part of the wireless resource; allocate the part of the wireless resource which the first cell has the right to allocate out of the wireless resource owned by the first cell to the terminal belonging to the first cell; and instruct the first wireless access lower layer processor to carry out wireless signal processing for the communication to/from the terminal by using the allocated part of the wireless resource; and the first wireless access lower layer processor is configured to: carry out, in accordance with the instruction to carry out the wireless signal processing, the wireless signal processing for the communication to/from the terminal by using the allocated part of the wireless resource; and notify the first wireless access upper layer processor of a result of the wireless signal processing which has been carried out.

According to one embodiment of this invention, the inter-cell cooperative processing can be realized with a small control overhead, and the combinations of the cells for the cooperative processing can be freely determined during the system operation. As a result, appropriate inter-cell cooperative processing can be carried out depending on an environmental change generated during a continuing service of the wireless communication system.

### BRIEF DESCRIPTION OF THE DRAWINGS

FIG. 1 is an explanatory diagram illustrating a distribution example of rights to allocate a wireless resource of a certain cell according to a first embodiment of this invention.

FIG. 2 is a block diagram of a configuration example of a wireless communication system according to the first embodiment of this invention.

FIG. 3 is a sequence diagram illustrating an example of processing to be carried out between a resource allocation rights controller and each of the cells according to the first embodiment of this invention.

FIG. 4 is an explanatory diagram of a first example of the information collected by the resource allocation rights controller from each cell according to the first embodiment of this invention.

FIG. 5 is an explanatory diagram of a second example of the information collected by the resource allocation rights controller from each cell according to the first embodiment of this invention.

FIG. 6A is an explanatory diagram of entire information representing a result of a resource allocation right distribution according to the first embodiment of this invention.

FIG. 6B is an explanatory diagram of a resource allocation rights information according to the first embodiment of this invention.

FIG. 6C is an explanatory diagram of a first example having a format of specifying frequency resources for which the allocation rights are held out of the allocation rights information according to the first embodiment of this invention.

FIG. 6D is an explanatory diagram of a second example having a format of specifying frequency resources for which the allocation rights are held out of the allocation rights information according to the first embodiment of this invention.

FIG. 7 is a sequence diagram illustrating an example of processing to be carried out between the resource allocation rights controller and each of the cells according to a second embodiment of this invention.

FIG. 8A is an explanatory diagram of a first example of an allocation right temporary waiver from a certain cell to another cell according to the second embodiment of this invention.

FIG. 8B is an explanatory diagram of a second example of the allocation right temporary waiver from a certain cell to another cell according to the second embodiment of this invention.

FIG. 9 is a block diagram illustrating an apparatus configuration of a communication system according to a fifth embodiment of this invention.

FIG. 10 is a block diagram illustrating an apparatus configuration of a communication system according to a sixth embodiment of this invention.

FIG. 11 is a block diagram illustrating an apparatus configuration of a communication system according to a seventh embodiment of this invention.

FIG. 12 is a block diagram illustrating an apparatus configuration of a communication system according to an eighth embodiment of this invention.

FIG. 13 is a sequence diagram illustrating a first example of processing to be carried out in the wireless communication system according to the eighth embodiment of this invention.

FIG. 14 is a sequence diagram illustrating a second example of processing to be carried out in the wireless communication system according to the eighth embodiment of this invention.

FIG. 15 is an explanatory diagram of an example of a terminal allocation right setting notification notified from each cell to a centralized resource allocator according to the eighth embodiment of this invention.

FIG. 16 is a sequence diagram illustrating an example of an operation of adding or deleting a cell to/from the resource allocation rights controller according to a fourth embodiment of this invention.

### DETAILED DESCRIPTION OF THE PREFERRED EMBODIMENTS

A description is now given of embodiments referring to the drawings.

### First Embodiment

A description is now given of a mode for embodying this invention independently of an apparatus configuration.

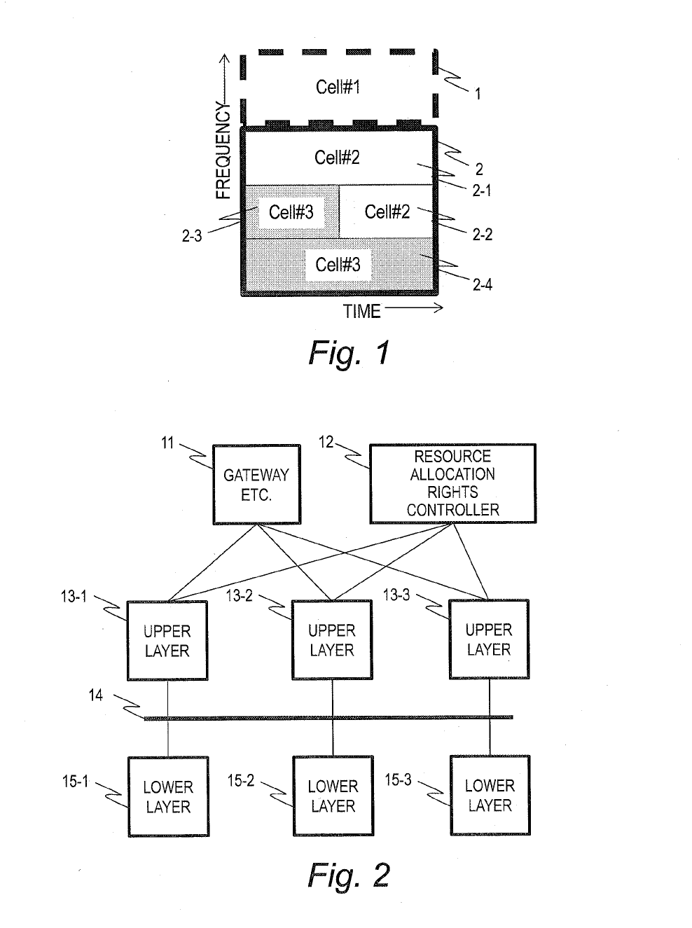

FIG. 1 is an explanatory diagram illustrating a distribution example of rights to allocate a wireless resource of a certain cell (Cell#1) according to a first embodiment of this invention.

The wireless resource of the cell (Cell#1) extends in a time direction and a frequency direction, thereby enabling division of an area to be allocated in the time and frequency domains. In the example of FIG. 1, an entirety including an area (a first wireless resource area 1) enclosed by thick solid lines and an area (a second wireless resource area 2) enclosed by thick broken lines is a wireless resource of the cell (Cell#1), namely, a wireless resource which the cell (Cell#1) has a right to allocate in the initial state. A width in the frequency direction of the wireless resource of the cell (Cell#1) is at least a part of a system bandwidth owned by the wireless communication system. A width in the time direction represents a certain unit period such as a unit of 10 milliseconds, and the same wireless resource allocation right distribution is repeatedly applied implicitly every 10 milliseconds unless the illustrated wireless resource allocation right distribution is explicitly carried out again.

Cells (such as Cell#2 and Cell#3) other than the cell also respectively include wireless resources, which are not shown in FIG. 1. For example, Cell#2 and Cell#3 may have, as wireless resources, frequency bands different from that of the wireless resource of the Cell#1. Alternatively, for example, when the Cell#1, Cell#2, and Cell#3 are sectors respectively corresponding to ranges spatially different from one another, the respective cells may have the same frequency band as the wireless resources.

According to this embodiment, the allocation rights of the wireless resource of each cell may be provided for another cell. In the example of FIG. 1, the first wireless resource area 1 out of the entire wireless resource of the cell (Cell#1) is an area for which the cell itself (Cell#1) has an exclusive wireless resource allocation right, and cells other than Cell#1 cannot allocate the wireless resource area to terminals (not shown). The second wireless resource area 2 is an area for which the cells (Cell#2 and Cell#3) other than the cell have an exclusive wireless resource allocation rights, and Cell#1 cannot allocate the second wireless resource area 2 to terminals though the wireless resource area 2 is owned by Cell#1.

In the example of FIG. 1, the first wireless resource area 1 and the second wireless resource area 2 correspond to respective different frequency bands. The second wireless resource area 2 can further be subdivided by dividing in the frequency direction or the time direction. For example, the second wireless resource area 2 may be subdivided into a wireless resource area 2-1 which corresponds to a part of the frequency band of the second wireless resource area 2, a wireless resource area 2-2 which is a part of the second wireless resource area 2, and corresponds to a part of a time range of a frequency band different from the wireless resource area 2-1, a wireless resource area 2-3 which corresponds to a remaining time range of the same frequency band as the wireless resource area 2-2, and a wireless resource area 2-4 which is a part of the second wireless resource area 2, and corresponds to a frequency band different from the wireless resource areas 2-1 and 2-2. In this example, exclusive wireless resource allocation rights for the wireless resource areas 2-1 and 2-2 are owned by Cell#2, and exclusive wireless resource allocation rights for the wireless resource areas 2-3 and 2-4 are owned by Cell#3.

FIG. 1 exemplifies the allocation right distribution for the wireless resource of Cell#1, but allocation right distributions are defined also for Cell#2 and Cell#3 (not shown).

FIG. 2 is a block diagram of a configuration example of the wireless communication system according to the first embodiment of this invention.

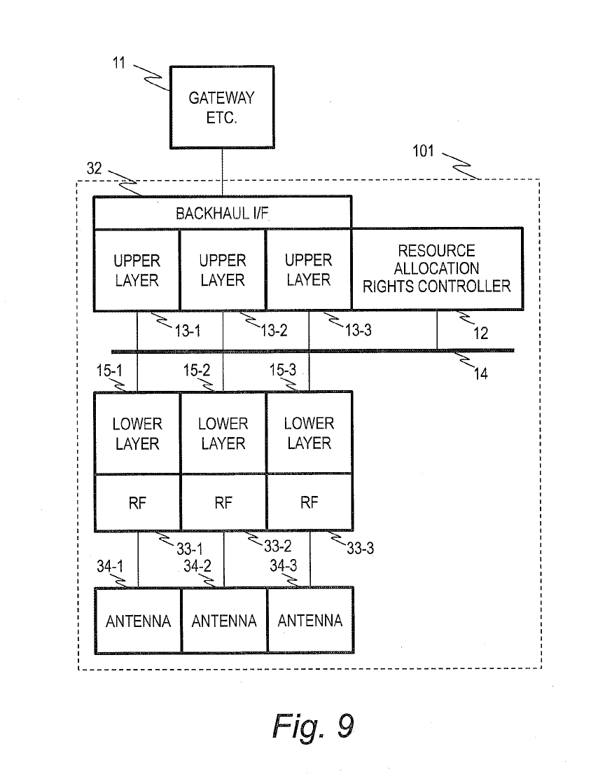

All of a plurality of function blocks illustrated in FIG. 2 may be arranged in a single base station apparatus for communicating wirelessly to/from a plurality of terminals (not shown), the plurality of function blocks may be arranged so as to be distributed to a plurality of base station apparatus, or a part of the function blocks may be arranged externally to the base station apparatus. A description is later given of at which locations the respective function blocks are arranged referring to other drawings, specifically, FIGS. 9 to 12.

A core network apparatus group 11 includes a gateway serving as a terminal end of data communication to/from a terminal (not shown), and a mobility management entity (MME) for managing data communication path considering locations of the respective terminals.

The resource allocation rights controller 12 determines a wireless resource allocation right distribution illustrated in FIG. 1. Specifically, the resource allocation rights controller 12 has functions of collecting wireless communication states relating to terminals belonging to each cell, determining the wireless resource allocation right distribution for the each cell based on the collected information, and notifying the each cell of the wireless resource allocation right distribution. The resource allocation rights controller 12 may determine the wireless resource allocation right distributions based on a certain algorithm based on the collected information, or may output the collected information from the user interface so that the wireless resource allocation right distributions may be manually determined. In any case, the determined wireless resource allocation right distribution is notified to the each cell.

Wireless access upper layer processors 13-1 to 13-3 are responsible for context management, data processing, and wireless resource allocation for terminals belonging to respective cells. Typically, processing to be carried out by the wireless access upper layer processors 13-1 to 13-3 includes processing on an upper layer including the medium access control (MAC) layer. FIG. 2 illustrates three wireless access upper layer processors 13-1 to 13-3. Each of the wireless access upper layer processors 13-1 to 13-3 corresponds to one cell (such as each of Cell#1 to Cell#3). When N (N is an arbitrary integer of 2 or larger) cells (such as Cell#1 to Cell#N) are set, the wireless communication system according to this embodiment includes N wireless access upper layer processors 13-1 to 13-N (not shown). Hereinafter, when a description common to any of the wireless access upper layer processors 13-1 to 13-N is given, the wireless access upper layer processors 13-1 to 13-N are also collectively referred to as wireless access upper layer processor 13.

A context of each terminal is managed by the wireless access upper layer processor 13 of the cell to which the terminal belongs, and the data addressed to the terminal is processed by the wireless access upper layer processor 13 to which the terminal belongs regardless of which wireless resource of a cell is to be used. As a typical example of the data processing, encryption and retransmission processing are conceivable. The wireless resource allocation is an operation by the wireless access upper layer processor 13 for each cell of referring to the wireless resource allocation right distribution, and allocating wireless resources of the own cell and other cells for which the cell has exclusive allocation rights to terminals belonging to the own cell.

Wireless access lower layer processors 15-1 to 15-3 are responsible for wireless signal processing for the respective cells. Typically, the processing to be carried out by the wireless access lower layer processors 15-1 to 15-3 corresponds to processing on the physical (PHY) layer. As for the wireless access upper layer processor 13, when N cells are set, the wireless communication system according to this embodiment has N wireless access lower layer processors 15-1 to 15-N (not shown). Hereinafter, when a description common to any of the wireless access lower layer processors 15-1 to 15-N, the wireless access lower layer processors 15-1 to 15-N are also collectively referred to as wireless access lower layer processor 15.

The wireless access lower layer processor 15 for the each cell carries out wireless signal processing for all terminals which use the wireless resource of the own cell for the wireless communication. All the terminals on this occasion include terminals managed by the wireless access upper layer processor 13 of the own cell and terminals managed by the wireless access upper layer processors 13 of other cells. A common transmission line 14 among the cells is provided for securing flexibility for transmitting information on the own cell and the other cells. The common transmission line 14 may be a common bus on a circuit board, or a network via switches as long as the common transmission line 14 is a transmission line shared among the wireless access upper layer processors 13 and the wireless access lower layer processors 15 of a plurality of cells.

A description is now given of a specific example. The encryption and the retransmission processing for data for communication between the terminals belonging to the wireless access upper layer processor 13-1 and the base station apparatus is processed by the wireless access upper layer processor 13-1. Wireless signal processing for the data after the above-mentioned processing is carried out by any one of the wireless access lower layer processors 15-1 to 15-3 depending on a result of the wireless resource allocation. When the inter-cell cooperation is not considered, the wireless signal processing for the data processed by the wireless access upper layer processor 13-1 is carried out by the wireless access lower layer processor 15-1, but flexibility is provided for the transmission line between the wireless access upper layer processor 13 and the wireless access lower layer processor 15 by providing the common transmission line 14 in order to realize the inter-cell cooperation.

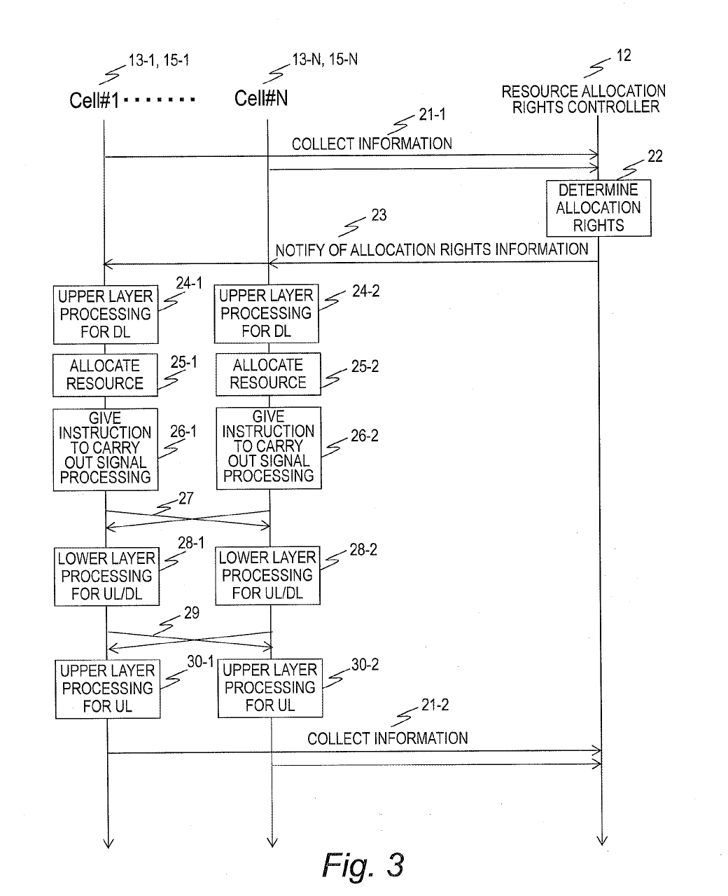

FIG. 3 is a sequence diagram illustrating an example of processing to be carried out between the resource allocation rights controller 12 and each of the cells according to the first embodiment of this invention.

The resource allocation rights controller 12 of FIG. 3 manages the allocation rights for N cells. Each of the cells includes the single wireless access upper layer processor 13 and the single wireless access lower layer processor 15.

The resource allocation rights controller 12 collects information (Step 21-1) from each of the cells in order to determine the wireless resource allocation right distribution.

The resource allocation rights controller 12 determines the wireless resource allocation distribution for each of the cells based on the information collected in Step 21 (Step 22), and notifies each of the cells of a distribution result (Step 23). It is assumed that the processing from the information collection to the notification of the resource allocation right distribution described above is carried out at a relatively long cycle. In other words, it is assumed that the wireless resource allocation itself is carried out every transmission time interval (TTI), specifically, for example, every some milliseconds to some tens of milliseconds, but the resource allocation right distribution is carried out in units of minutes, hours, or days, namely, at a cycle sufficiently longer than the TTI.

It is assumed that processing described below is carried out every TTI. The wireless access upper layer processor 13 for the each cell carries out upper layer processing for a downlink (DL) (Step 24), and carries out the wireless resource allocation for the DL and an uplink (UL) for the terminals belonging to the cell (Step 25). It should be noted that, in FIG. 3, Step 24 carried out by Cell#1 is denoted by Step 24-1, and Step 24 carried out by Cell#N is denoted by Step 24-2. The same branch numbers may also be added to step numbers up to 30. When the wireless resource allocation is completed, the wires access upper layer processor 13 instructs the wireless access lower layer processor 15 of the own cell or another cell to carry out wireless signal processing for the UL and DL (Step 26). The instruction to carry out the wireless signal processing between cells may be made depending on the resource allocation right distribution result (Step 27). When the wireless access lower layer processor 15 receives the instruction to carry out the wireless signal processing from the wireless access upper layer processor 13 of the own cell or another cell, the wireless access lower layer processor 15 carries out the wireless signal processing for the UL/DL (Step 28). The wireless signal processing result for the UL is notified to the wireless access upper layer processor 13. The wireless access upper layer processor 13 carries out upper layer processing based on the notified wireless signal processing result (Step 30). On this occasion, when an instruction to carry out the wireless signal processing between cells is given in Step 27, the UL wireless signal processing result is notified between the cells in a route opposite to the instruction of the wireless signal processing (Step 29).

For example, as illustrated in FIG. 1, when Cell#1 owns the allocation right to allocate the first wireless resource area 1 out of the wireless resource of Cell#1, the wireless access upper layer processor 13-1 of Cell#1 can allocate any of the wireless resource included in the first wireless resource area 1 to the terminal belonging to Cell#1 (Step 25-1). In this case, the wireless access upper layer processor 13-1 instructs the wireless access lower layer processor 15-1 of Cell#1 to carry out the wireless signal processing for the UL and DL (Step 26-1). The wireless access lower layer processor 15-1, which has received the instruction to carry out the wireless signal processing from the wireless access upper layer processor 13-1, carries out the wireless signal processing for the UL/DL by using the allocated wireless resource (Step 28-1). The wireless signal processing result for the UL is notified to the wireless access upper layer processor 13-1. The wireless access upper layer processor 13-1 carries out the upper layer processing based on the notified wireless signal processing result (Step 30-1).

Alternatively, as illustrated in FIG. 1, when Cell#2 holds the rights to allocate the wireless resource areas 2-1 and 2-2 included in the second wireless resource area 2 out of the wireless resource of Cell#1, the wireless access upper layer processor 13-2 of Cell#2 can allocate wireless resources included in the wireless resource areas 2-1 and 2-2 to terminals belonging to the Cell#2 (Step 25-2). In this case, the wireless access upper layer processor 13-2 instructs the wireless access lower layer processor 15-1 of Cell#1 to carry out the wireless signal processing for the UL and DL (Steps 26-2 and 27). The wireless access lower layer processor 15-1, which has received the instruction to carry out the wireless signal processing from the wireless access upper layer processor 13-2, carries out the wireless signal processing for the UL/DL by using the allocated wireless resource (Step 28-1). The wireless signal processing result for the UL is notified to the wireless access upper layer processor 13-2 (Step 29). The wireless access upper layer processor 13-2 carries out the upper layer processing based on the notified wireless signal processing result (Step 30-2).

For example, when the Cell#2 is congested and the wireless resource of Cell#2 is stringent as a result while the wireless resource of Cell#1 is affluent, the congestion can be alleviated by allocating at least a part of the wireless resource of Cell#1 to the terminals belonging to the Cell#2 as described above.

Alternatively, when each of the cells is a sector partitioned spatially and has the same frequency band as the wireless resource, for example, when Cell#2 has a right to allocate the wireless resource area 2-1 and also has a right to allocate the wireless resource (not shown, herein denoted by wireless resource B) having the same frequency as the wireless resource area 2-1 out of the wireless resources of Cell#2 itself, the wireless access upper layer processor 13-2 may allocate the wireless resource B to the terminal, may instruct the wireless access lower layer processor 15-2 to carry out the wireless signal processing for the UL and DL by using the wireless resource B, and may instruct the wireless access lower layer processor 15-1 not to carry out communication by using the wireless resource area 2-1. As a result, interference between the cells can be restrained.

When the UL upper layer processing (Step 30) has been completed, each of the cells can acquire data to be forwarded to the gateway and control information as well as information required by the resource allocation rights controller 12. For example, each of the cells can acquire report on a measurement result, which is measured by a terminal belonging to each of the cell, of a received electric power of a DL signal for the assigned cell and neighboring cells.

On this occasion, the assigned cell is a cell to which each of the terminals belongs, and the neighboring cell is a cell in a neighborhood of the assigned cell. Each of the terminals can also receive a wireless signal of a cell other than the assigned cell in some cases. For example, when a terminal belonging to a certain cell A can also receive (or may receive) a wireless signal of another cell B, the cell B is preferably treated as a neighboring cell of the cell A. Typically, for example, cells managed by the same base station apparatus as that managing the assigned cell, cells managed by base station apparatus located geometrically close to the base station apparatus managing the assigned cell, and the like are treated as neighboring cells. Information representing which cells are neighboring cells of each cell may be held by the each cell, or all cells which transmit wireless signals actually received by terminals belonging to the each cell may be treated as neighboring cells.

The each cell successively reports the information acquired from the terminals belonging to the each cell to the resource allocation rights controller 12 (Step 21-2). The each cell may carry out the report in Step 20-2 each time a sequence of processing of Step 24 to Step 30 is carried out (in other words, once every TTI), but, even in this case, the resource allocation rights controller 12 does not determine the wireless resource allocation right distribution each time the report is received. This embodiment aims to reduce the control overhead caused by the inter-cell cooperation by the resource allocation rights controller 12 determining the right distribution by taking a cycle sufficiently longer than TTI, and carrying out the resource allocation right distribution report at the long cycle such as in units of minutes, hours, or days. For this purpose, each cell may carry out the report in Step 21-2 not once every TTI but at a predetermined interval longer than the TTI and shorter than the interval of determining the resource allocation right distribution or only immediately before a timing at which the resource allocation right distribution is determined.

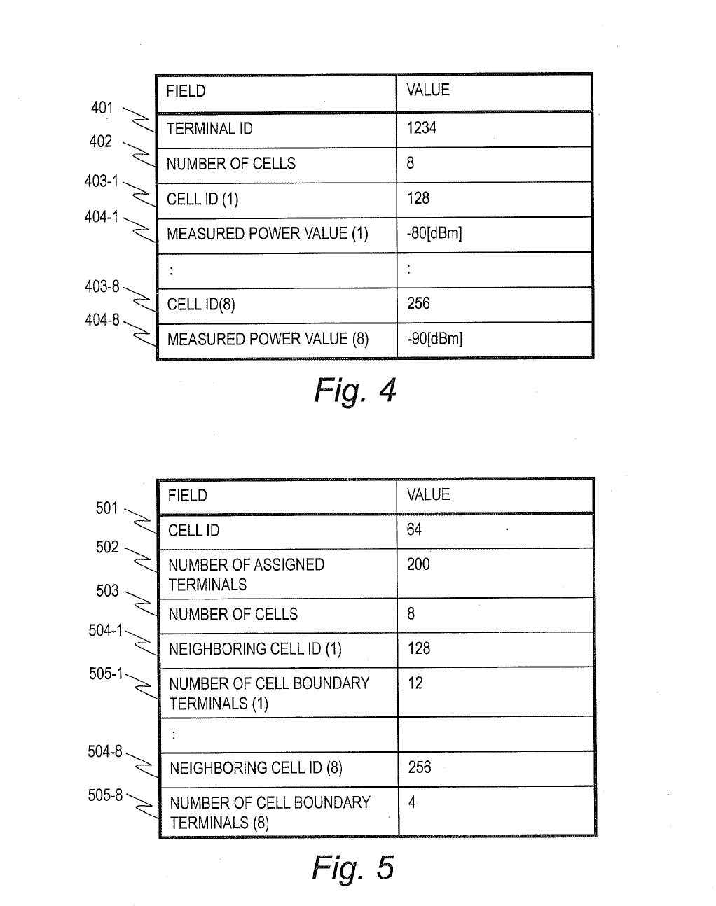

FIG. 4 is an explanatory diagram of a first example of the information collected by the resource allocation rights controller 12 from each cell according to the first embodiment of this invention.

A terminal ID 401 is an identifier of a terminal (specifically, a terminal which has measured power measurement values relating to at least one cell included in the information) relating to the collected information. The terminal ID 401 is used to overwrite the information by the last reported value or to distinguish the information from information received from other terminals when a report on the same cell is notified a plurality of times from the same terminal. A number of cells 402 is a number of reports for cells in the following fields. For each of the cells, a cell ID, and a DL received electric power measured by the terminal, and relating to the cell is reported.

In the example of FIG. 4, the values of the terminal ID 401 and the number of cells 402 are respectively “1234” and “8”. This represents a situation where the number of neighboring cells of the assigned cell of a terminal (the terminal is hereinafter also referred to as “1234”) having “1234” as the value of the terminal ID 401 is 7. For example, when a value “128” of a cell ID (1) 403-1 is the ID of an assigned cell, the value “−80 dBm” of an electric power measurement value (1) 404-1 represents a received strength of the wireless signal of the assigned cell measured by the terminal “1234”. In this case, a value “256” of a cell ID (8) 403-8 is the ID of a neighboring cell, the value “−90 dBm” of an electric power measurement value (8) 404-8 represents a received strength of the wireless signal of the neighboring cell measured by the terminal “1234”. The information shown in FIG. 4 further includes another six IDs of neighboring cells, and electric power measurement values representing received strengths, which are not shown in FIG. 4. Each terminal transmits the measurement result to the assigned cell each time the terminal measures the received electric power of the wireless signal of the assigned cell or the neighboring cell, and each cell transmits the information shown in FIG. 4 including the measurement result to the resource allocation rights controller 12 each time the cell receives the measurement result from a belonging terminal.

The resource allocation rights controller 12 carries out the wireless resource allocation right distribution based on the information collected in this way. An important point relating to the right distribution is how many terminals (in other words, terminals estimated to be located close to a boundary between a certain cell (such as Cell#1) and neighboring cells (such as Cell#2 and Cell#3 thereof)) having difference in power measurement value of the wireless signal between the certain cell and the neighboring cells thereof within a threshold exist. For example, when a terminal belonging to Cell#2 is located close to a boundary between Cell#1 and Cell#2, the wireless resource of Cell#1 is estimated to be used for the communication to/from the terminal.

Specifically, a ratio between the first wireless resource area 1 and the second wireless resource area 2 relating to Cell#1 can be determined from a ratio between a number of terminals each of which is out of terminals belonging to the neighboring cell, and has the difference in power measurement value of the wireless signal between Cell#1 and the neighboring cell within the threshold and the total number of terminals belonging to Cell#1. The allocation right distribution for the plurality of neighboring cells in the second wireless resource area 2 is determined based on a percentage of a number of terminals each having the difference in power measurement value from Cell#1 within the threshold for each of the neighboring cells with respect to the total number of the terminals of all the neighboring cells.

For example, when the total number of terminals belonging to Cell#1 is 100, the number of terminals close to the boundary between Cell#1 and Cell#2 is 150, the number of terminals close to the boundary between Cell#1 and Cell#3 is 150, the resource assignment rights controller 12 may divide the wireless resource of Cell#1 as 100:150:150, in other words, 25%:37.5%:37.5%, and may respectively allocate 25% to communication to/from the terminals belonging to Cell#1, 37.5% to communication to/from the terminals belonging to Cell#2, and remaining 37.5% to communication to/from the terminals belonging to Cell#3. A resource of a cell other than that of a cell to which a terminal located close to a boundary between the cells belongs can flexibly be allocated to the terminal by distributing the right in this way, and a consumed quantity of the resource can be distributed among cells.

When the distribution ratio of the wireless resource allocation right is determined, the distribution ratio can be divided into the time domain and the frequency domain as illustrated in FIG. 1. In terms of the acquisition of flexibility of the frequency resource in each TTI, the division in the time domain needs to be prioritized and the division in the frequency domain needs to be avoided as much as possible, but, in terms of maintenance of equal time interval retransmission of the hybrid ARQ (HARQ), the wireless resource allocation right is distributed at a constant time interval, and division of the frequency domain by priority also becomes necessary.

When these conditions are considered, the information reported by the each cell may be output via a user interface so that the wireless resource allocation right distribution ratio and the division method for time/frequency may be manually determined, or a certain internal algorithm may be used for the determination in place of the manual determination.

FIG. 5 is an explanatory diagram of a second example of the information collected by the resource allocation rights controller 12 from each cell according to the first embodiment of this invention.

In place of the information on each terminal to be reported by each cell to the resource allocation rights controller 12 shown in FIG. 4, in the example shown in FIG. 5, a result of statistical processing carried out by the cell on the information collected by the each cell from the each terminal is reported to the resource allocation rights controller 12. Specifically, information on the own cell such as an identifier 501 of a cell, which is a report source, and a total number 502 of terminals coupled to the cell, a number of cells 503 representing the number of neighboring cells, an identifier (neighboring cell ID 504) of each of the neighboring cells, and a number of cell boundary terminals 505 of each of the neighboring cells are reported. On this occasion, the number of cell boundary terminals 505 is a total number of terminals each of which belongs to the cell, and has a difference in DL received electric power from the assigned cell at the terminal for each of the neighboring cells is within the threshold. When the difference between the DL received electric power for the assigned cell and the DL received electric power for the neighboring cell of the certain terminal is small, it is assumed that the terminal is located in a neighborhood of the boundary between the assigned cell and the neighboring cell. In other words, the number of cell boundary terminals 505 is the number of terminals located on the boundary between the assigned cell and the neighboring cell, and is totaled and reported for each of the neighboring cells.

Both of the pieces of the information of FIGS. 4 and 5 include the power measurement result by each terminal, but, while the information shown in FIG. 4 includes the measured electric power value itself, the information shown in FIG. 5 includes a result of statistical processing applied to the power value. The statistical processing may be carried out by any of the each cell and the resource allocation rights controller 12. In other words, compared with the collection of the information shown in FIG. 4, the collection of the information shown in FIG. 5 reduces an arithmetic operation load on the resource allocation rights controller 12, but increases a time for the statistical processing in the each cell, and hence any of the cases may be selected depending on the apparatus configuration of the system.

FIG. 5 shows, as an example, information transmitted at a certain time from a cell (hereinafter also referred to as cell “64”) identified by a value “64” of the cell ID 501. In this example, 200 terminals belong to the cell “64”, and eight neighboring cells of the cell “64” exist. A value “128” of a neighboring cell ID (1) 504-1 and a value “12” of a number of cell boundary terminals (1) 505-1 represent a state where the cell ID of one of the eight neighboring cells is “128”, and the number of terminals estimated to be located close to the boundary between the neighboring cell and the cell “64” is “12”. Similarly, a value “256” of a neighboring cell ID (8) 504-8 and a value “4” of a number of cell boundary terminals (8) 505-8 represent a state where the cell ID of one of the eight neighboring cells is “256”, and the number of terminals estimated to be located close to the boundary between the neighboring cell and the cell “64” is “4”. The information shown in FIG. 5 further includes information on cell IDs of the remaining 6 neighboring cells and the numbers of terminals close to boundaries between the respective neighboring cells and the cell “64”, which is not shown in FIG. 5.

In the example of FIG. 4, when the each cell receives the report from the terminal, the each cell forwards the report to the resource allocation rights controller 12, while, in the example of FIG. 5, the each cell collects report from terminals for a certain period in the cell, applies the statistical processing to the reports, and then notifies the resource allocation rights controller 12 of the result. In this case, the cycle of the notification from each cell to the resource allocation rights controller 12 is set in advance.

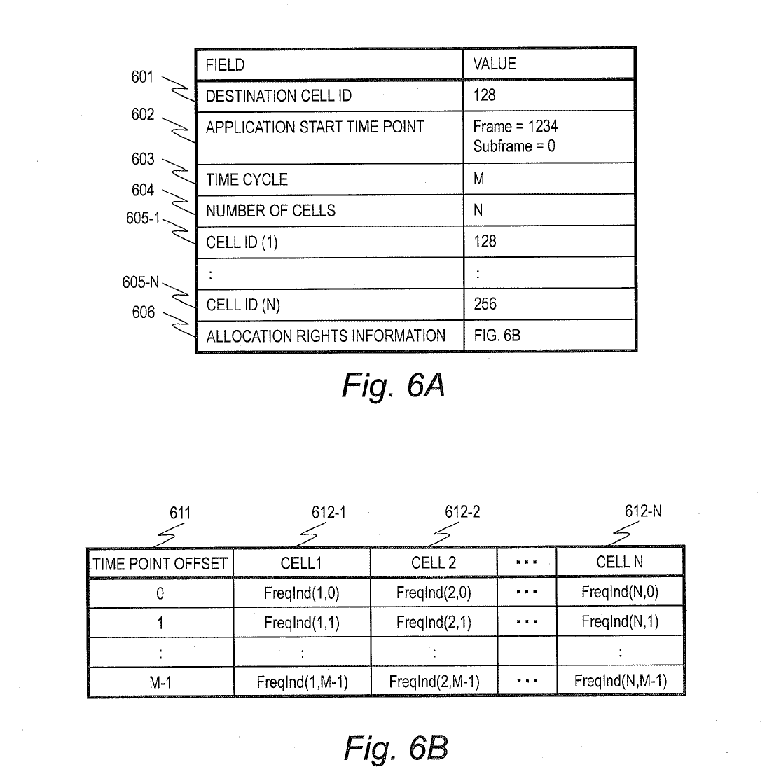

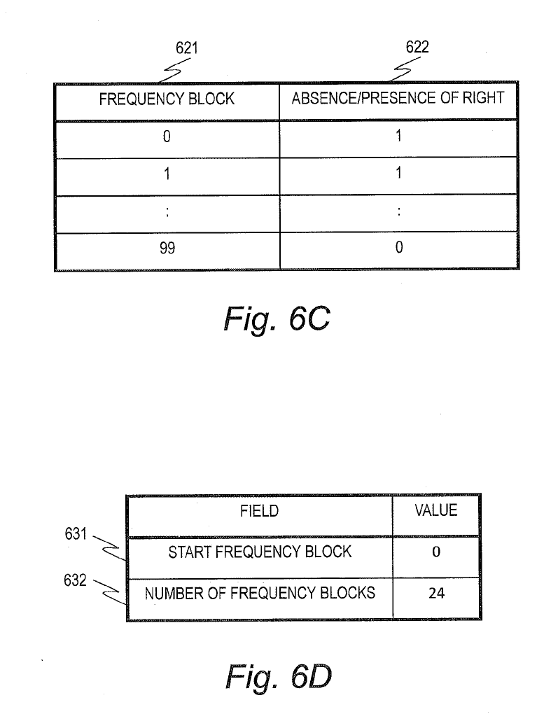

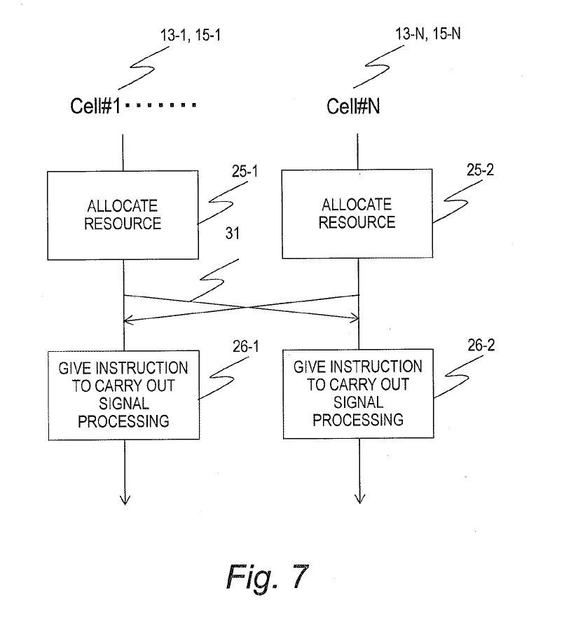

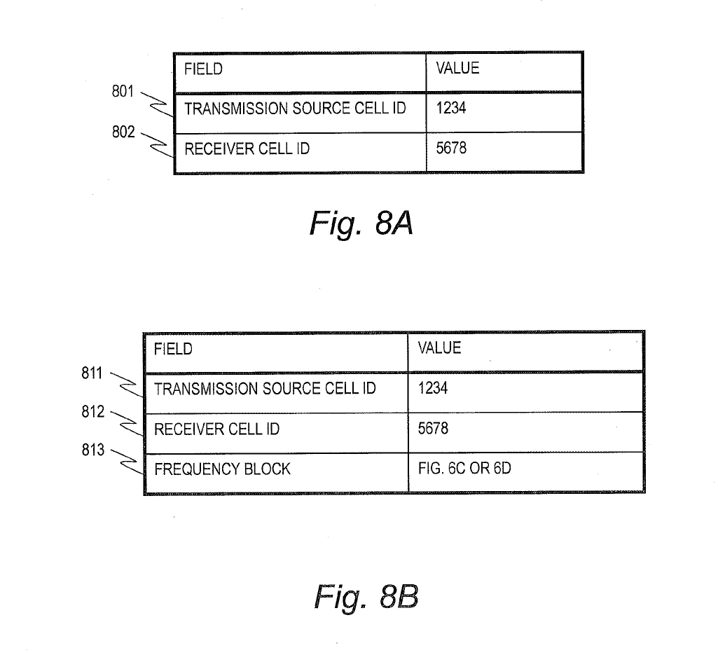

FIGS. 6A to 6D show specific examples of the resource allocation right distribution notified from the resource allocation controller according to the first embodiment of this invention to the each cell.

FIG. 6A shows entire information representing a result of the resource allocation right distribution according to the first embodiment of this invention.

As information to be included in the entire resource allocation right distribution, an identifier (destination cell ID 601) of a cell to receive the information, an application start time point 602 of the resource allocation right distribution represented by the information, a time cycle 603 of repeated application of a rule represented by the resource allocation right distribution, a number 604 of cells including a cell to receive this information and other cells for which the allocation right is held by this cell, respective identifiers (cell ID (1) 605-1 to cell ID (N) 605-N), and details of the allocation rights information (allocation rights information 606) are conceivable. As the application start time point 602, a frame number and a sub-frame number defined in the wireless communication system are preferably used in terms of the control of each cell. Details of the allocation rights information in the last row are shown in FIG. 6B.

FIG. 6B is an explanatory diagram of the resource allocation rights information according to the first embodiment of this invention.

The detailed allocation rights information is constructed by data arranged two dimensionally including time offsets 611 and cell indices 612-1 to 612-N. The time offsets 611 are a value treated in a cyclic manner so that the offset is 0 at the operation start time point of FIG. 6A, is incremented by 1 for each TTI such as the sub-frame, and returns to 0 for an offset of M. The cell indices 612-1 to 612-N are respectively associated with the cell ID (1) 605-1 to cell ID (N) 605-N. A frequency index (FreqInd) of FIG. 6A represents a detailed position of a frequency resource for which the right to allocate is held for each of the cells including the own cell and other cells at each time point. FIGS. 6C and 6D show details thereof.

FIG. 6C is an explanatory diagram of a first example having a format of specifying frequency resources for which the allocation rights are held out of the allocation rights information according to the first embodiment of this invention. Positions of the frequency resources for which the allocation rights are held are represented as a bit map. Specifically, the information of FIG. 6C includes absence/presence of right 622 for each of the frequency blocks 621.

The frequency block 621 is a value for identifying each frequency block acquired by dividing the frequency band, which is the wireless resource of each cell. In the example of FIG. 6C, the frequency band is divided into 100 frequency blocks, and values of 0 to 99 are set to the frequency blocks 621.

A value “1” of the absence/presence of right 622 corresponding to each of the frequency blocks represents that the allocation right relating to the frequency block is held, and “0” represents that the allocation right relating to the frequency block is not held.

FIG. 6D is an explanatory diagram of a second example having a format of specifying frequency resources for which the allocation rights are held out of the allocation rights information according to the first embodiment of this invention. In this example, a value of a start frequency block 631 and a value of a number of frequency blocks 632 are specified. The frequency blocks in this example may be the same as those shown in FIG. 6C. For example, a value “0” of the start frequency block 631, and a value “24” of the number of frequency blocks represent such a state that allocation rights are held for the 24 frequency blocks from the 0th frequency block to the 23rd frequency block, and the allocation rights for the other frequency blocks are not held.

Irrespective of whether the format of FIG. 6C or the format of FIG. 6D is employed, an object to be achieved by this invention can be achieved. For example, as illustrated in FIG. 1, information for identifying the portions for which the allocation rights are respectively held by the Cell#1, Cell#2, and Cell#3 out of the wireless resource of Cell#1 can be described by a combination of FIGS. 6B and 6C, a combination of FIGS. 6B and 6D, or a combination of all thereof. The same holds true for such a case that a right to allocate a part of a wireless resource of Cell#2 is distributed to Cell#2, and a right to allocate another part is distributed to Cell#1, which is not shown in FIG. 1.

The wireless access upper layer processor 13 for each cell holds information shown in FIGS. 6A to 6D received from the resource allocation rights controller 12, and can identify a right to allocate which wireless resource (such as a frequency block) of which cell is held by the own cell at an arbitrary time point based on the information.

According to the first embodiment of this invention, it is possible to realize a wireless communication system having a large number of cells for centrally carrying out, for a plurality of cells, the wireless resource allocation right distribution for dividing a wireless resource owned by each cell into a first wireless resource area for which the cell itself has an exclusive allocation right and a second wireless resource area for which cells other than the cell itself have exclusive allocation rights. As a result, the control overhead for adjusting the resource usage requests among cells can be reduced by the wireless resource allocation right distribution, and the flexibility of the combination of the cells for the cooperative processing can be increased by carrying out the wireless resource allocation right distribution during the system operation.

### Second Embodiment

A description is now given of a mode for embodying this invention which is improved from the first embodiment. The wireless communication system according to a second embodiment of this invention may be the same as that of the wireless communication system according to the first embodiment except for a different point described below, and illustrations and descriptions of parts other than the different point are omitted. Moreover, descriptions of parts denoted by the same reference numerals as those for the parts of the first embodiment out of illustrated parts of the second embodiment are the same as those of the parts of the first embodiment, and are thus omitted.

In the first embodiment, the resource allocation rights controller 12 determines the distribution of the resource allocation rights for a cell itself and other cells for each cell, and notifies each cell of the determined distribution. When the cell which has received the notification does not use a resource allocation right for another cell in a certain TTI, because the right is an exclusive right, a terminal allocation to the resource does not occur, and a radio wave is thus absent. This phenomenon may decrease a frequency usage efficiency in the wireless communication system, and a mechanism is thus introduced to avoid the phenomenon, thereby increasing the frequency usage efficiency. FIG. 7 specifically illustrates the mechanism.

FIG. 7 is a sequence diagram illustrating an example of processing to be carried out between the resource allocation rights controller 12 and each of the cells according to the second embodiment of this invention.

It should be noted that FIG. 7 illustrates only parts different in operation sequence from that of FIG. 3. Specifically, such an operation sequence that Steps 25 and 26 out of the processing illustrated in FIG. 3 are replaced by Steps 25 and 26 and Step 31 therebetween illustrated in FIG. 7 is carried out in the communication system according to this embodiment. This is an operation sequence of temporarily waiving the resource allocation right for another cell. The resource allocation rights controller 12 does not involve in the operation itself, and the operation is realized only by the communication between cells.

Each cell refers to the allocation right distribution notified from the resource allocation rights controller 12, thereby carrying out wireless resource allocation of wireless resources of the cell itself and other cells to the terminals belonging to the cell itself every TTI (Step 25). When a right to allocate another wireless cell resource in the TTI is not used in the wireless resource allocation, the allocation right relating to the other cell is temporarily waived, and the right to allocate is temporarily returned to the other cell (Step 31). Specifically, in Step 31, each cell may notify another cell of information for identifying a wireless resource of the other cell for which the cell itself has the allocation right, but which is not allocated, which is shown in, for example, FIGS. 8A and 8B.

The other cell, which has received the right waiver notice, reallocates the waived frequency block to a terminal belonging to the other cell. In the sequence diagram of FIG. 7, the other cell expects that the right waiver notification is received, and carries out the resource allocation for a part, as a substitute, for which the allocation right is not held out of the wireless resource of the other cell. When the right waiver notification is received, the other cell carries out resource allocation of the substitute, and when the right waiver notification is not received, gives up the resource allocation of the substitute in the TTI. Therefore, in FIG. 7, processing for reallocation after the right waiver notification is not illustrated as the operation sequence. However, this is only an example of implementation relating to a chronological order between the timing at which the resource for which the right is waived is allocated and the timing at which the right waiver is notified. For example, in place of the substitute resource allocation, after Step 31 and before Step 26, a step of allocating the notified (temporarily waived) wireless resource may be inserted. Any of the methods can solve the object to be solved.

After the sequence of processing relating to the right waiver in Step 31 is finished, the wireless access upper layer processor 13 instructs the wireless access lower layer processor 15 of the own cell or another cell to carry out the wireless signal processing for the UL and DL as in the first embodiment (Step 26). In the next TTI, the temporary allocation right waiver is reset, and the wireless access upper layer processor 13 again refers to the allocation right distribution notified from the resource allocation rights controller 12, and allocates the wireless resources of the own cell and other cells to the terminals belonging to the own cell (Step 25).

The right waiver notification in Step 31 is the control overhead relating to the inter-cell cooperation carried out at the TTI cycle, but the notification is a one-way notification from the cell holding the allocation right to the cell originally owning the resource, and a response from the reception side is not necessary. The overhead is the minimum control overhead for preventing a temporal waiver of the allocation right for a resource of another cell from decreasing the frequency usage efficiency.

The right waiver notification is issued from the wireless access upper layer processor 13-1 of Cell#1, for example, when one of the terminals belonging to Cell#1 for which the cooperative processing with Cell#2 is determined to be effective does not have data to be communicated. The determination as to whether the cooperative processing with another cell is effective or not is made based on an electric power measurement value reported from a terminal as shown in FIG. 4. In other words, when another cell having the difference in power measurement value from the cell to which the terminal belongs within the threshold exists, the cooperative processing for the terminal is determined to be effective.

FIGS. 8A and 8B are explanatory diagrams of examples of the allocation right temporary waiver from a certain cell to another cell according to the second embodiment of this invention.

FIG. 8A shows a configuration of the right waiver notification for a certain cell (in the example of FIG. 8A, a cell identified by a value “1234” of a transmission source cell ID 801, and hereinafter also referred to as cell “1234”) to entirely waive the rights to allocate the wireless resource of another cell (a cell identified by a value “5678” of a receiver cell ID 802, and hereinafter also referred to as cell “5678”) notified from the resource allocation rights controller 12 in a TTI in which the allocation right waiver notification is transmitted. In the next TTI, the right waiver notification is reset.

FIG. 8B shows a configuration of the right waiver notification of such a case that the waiver of the allocation right is limited to a part of the frequency block in the TTI. A transmission source cell ID 811 and a receiver cell ID 812 of FIG. 8B respectively correspond to the transmission source cell ID 801 and the receiver cell ID 802 of FIG. 8A, and the same values as those of FIG. 8A are respectively exemplified. A frequency block 813 is information representing that, as shown in FIG. 6C or 6D, the allocation right of which frequency block is waived by the transmission source cell, and can thus be used by the receiver cell.

As a result, only the allocation right for the frequency block identified by the frequency block 813 out of the wireless resource of the cell “5678” for which the cell “1234” holds allocation rights is waived in the TTI in which the allocation waiver notification is transmitted, which is different from the case of FIG. 8A. The cell “5678” can allocate the frequency block for which the allocation right is waived only in the TTI.

When a traffic on the terminal is low, a frequency of using the wireless resource decreases, and the allocation right waiver notification shown in FIGS. 8A and 8B can thus be issued in a successive plurality of TTIs. Thus, the communication overhead relating to the allocation right waiver notification can be reduced by providing each cell with a setting parameter representing whether or not to operate the function of carrying out allocation right waiver notification, and adding a mechanism capable of changing the setting parameter during the operation.

### Third Embodiment

A third embodiment of this invention is an embodiment of message transmission relating to a wireless signal processing instruction between the wireless access upper layer processor 13 and the wireless access lower layer processor 15. The wireless communication system according to the third embodiment may be the same as any one of or a combination of the wireless communication systems according to the first and second embodiments except for a different point described below, and illustrations and descriptions of parts other than the different point are omitted.

In Femto Forum, “LTE eNB L1 API Definition v1.1”, Femto Forum Technical Document, pp. 39-104 (October 2010), there is disclosed an embodiment of an interface between software on L2/L3 corresponding to the wireless access upper layer processor 13 according to this invention and software on layer L1 corresponding to the wireless access lower layer processor 15 according to this invention.

According to this document, before the wireless access lower layer processor 15 is logically activated, the wireless access upper layer processor 13 configures the wireless access lower layer processor 15. A CONFIG.request message according to this document includes a field for setting a cell ID. After the configuration, the wireless access upper layer processor 13 activates the wireless access lower layer processor 15, carries out setting required for the wireless signal processing for each TTI, and transmits data body subject to the signal processing. It is assumed that the setting for each TTI is setting required for signal processing relating to terminals corresponding to a cell ID configured initially. In other words, the assumption means that the setting required for the wireless signal processing cannot be carried out for terminals belonging to a cell different in cell ID.

As many cell IDs as necessary are added to the setting for each TTI in order to solve the problem. Specifically, various protocol data units (PDUs) are defined in DL_CONFIG.request and UL_CONFIG.request according to this document and by specifying a cell ID for each PDU, the wireless signal processing setting (Step 27 of FIG. 3) between cells from the wireless access upper layer processor 13 to the wireless access lower layer processor 15, and the notification (Step 29 of FIG. 3) between the cells in the opposite direction, which are to be realized by this invention, can be carried out.

### Fourth Embodiment

In a fourth embodiment of this invention, a description is given of such an operation example that in a situation where the resource allocation rights controller 12 is under operation, a newly added cell is to be recognized by the resource allocation rights controller 12 or a cell already recognized is to be deleted. The wireless communication system according to the fourth embodiment may be the same as any one of or a combination of the wireless communication systems according to the first to third embodiments except for a different point described below, and illustrations and descriptions of parts other than the different point are omitted. Moreover, a description of parts denoted by the same reference numerals as those for the parts of the first to third embodiments out of illustrated parts of the fourth embodiment is the same as the description of the parts of the first to third embodiments unless a different point is described below, and is thus omitted.

FIG. 16 is a sequence diagram illustrating an example of an operation of adding or deleting a cell to/from the resource allocation rights controller 12 according to the fourth embodiment of this invention. It should be noted that the sequence of this embodiment occurs in response to an event of adding or deleting a cell, and coexists with the first to third embodiments.

The wireless access upper layer processor 13 of a cell to be added to or deleted from the resource allocation rights controller 12 issues a request, as a message, to add or delete the cell to the resource allocation rights controller 12 (Step 39). The message of Step 39 includes a cell ID of an issuance source of the request and a notification type (ADD: addition of a cell or REMOVE: removal of a cell).

The resource allocation rights controller 12 which has received the message determines whether the request can be accepted or not (Step 40). For example, as a condition not to accept the addition of a cell, such a condition that the cell is already registered, such a condition that hardware resources (memory capacity and a calculation performance) of the resource allocation rights controller 12 are insufficient, and the like are conceivable. As a condition not to accept the deletion of a cell, such a condition that the cell is not registered is conceivable. When the exemplified conditions not to accept the message can be avoided, the resource allocation rights controller 12 accepts the request message of Step 39.

When the resource allocation rights controller 12 accepts the request message in Step 39, the resource allocation rights controller 12 carries out such a notification that the request message can be accepted as a response message (Step 41). On the other hand, when the resource allocation rights controller 12 determines that the request message of Step 39 cannot be accepted in Step 40, the resource allocation rights controller 12 carries out such a notification that the request message cannot be accepted. When the notification of unacceptability is carried out, a cause for the unacceptability such as insufficient hardware resources may be notified as well.

### Fifth Embodiment

In a fifth embodiment of this invention, a description is given of a first example of an apparatus configuration for realizing the first to fourth embodiments. The wireless communication system according to the fifth embodiment may be the same as any one of or a combination of the wireless communication systems according to the first to fourth embodiments except for a different point described below, and illustrations and descriptions of parts other than the different point are thus omitted. Moreover, a description of parts denoted by the same reference numerals as those for the parts of the first to fourth embodiments out of illustrated parts of the fifth embodiment is the same as the description of the parts of the first to fourth embodiments unless a different point is described below, and is thus omitted.

FIG. 9 is a block diagram illustrating an apparatus configuration of the communication system according to the fifth embodiment of this invention.

The apparatus configuration example illustrated in FIG. 9 is such an example that the resource allocation rights controller 12 is arranged in the base station apparatus 101 for managing a plurality of cells, and the resource allocation rights controller 12 distributes the resource allocation rights for all the cells in the base station apparatus 101. It is assumed that a large number of the same base station apparatus 101 are arranged in the wireless communication system.

A description is now given of function blocks, and a description of function blocks the same in function as those of FIG. 2 is omitted.

A backhaul interface 32 is a device for backhaul communication to/from a core network apparatus group 11, and shared by the wireless access upper layer processors 13 of a plurality of cells.

The wireless access lower layer processor 15 is coupled via a wireless frequency signal processor 33 to an antenna 34. In FIG. 9, wireless frequency signal processors 33-1 to 33-3 and antennas 34-1 to 34-3 corresponding to wireless access lower layer processors 15-1 to 15-3, respectively, are illustrated for each cell, but when the cells in the base station apparatus 101 are multiplexed in the frequency domain, a plurality of cells may share one wireless frequency signal processor 33 and one antenna 34. It should be noted that the wireless frequency signal processor 33 is constructed by a digital/analog converter, an analog/digital converter, an up converter, a down converter, and an amplifier (none of them are shown). When a plurality of cells are multiplexed in the frequency domain, the wireless frequency signal processor 33 further includes a multiplexer and a demultiplexer (none of them are shown) for multiplexing and demultiplexing a plurality of cell signals.

The resource allocation rights controller 12 and the wireless access upper layer processor 13 for each cell are coupled to one another via the common transmission line 14. In this embodiment, the common transmission line 14 is realized as a common bus routed on a circuit board. The common bus is also shared by the wireless access lower layer processor 15 for each cell. Message transmission for the control described in the first and second embodiments is carried out between the resource allocation rights controller 12 and the wireless access upper layer processor 13 for each cell.

It should be noted that the resource allocation rights controller 12, the wireless access upper layer processor 13 for each cell, and the wireless access lower layer processor 15 for each cell may respectively be realized by dedicated logical circuits provided in the each base station apparatus 101, or may respectively be realized by at least one general-purpose processor (not shown) provided in the each base station apparatus 101 executing a program stored in a memory (not shown) provided in the each base station apparatus 101.

A point of the embodiment is such a point that the resource allocation rights controller 12 and the wireless access upper layer processor 13 for each cell is coupled via the common bus routed on the circuit board. The number of cells managed by the base station apparatus 101 is not limited to three. The number of cells can be increased as long as an amount of data communicated among the three function blocks of the resource allocation rights controller 12, the wireless access upper layer processor 13, and the wireless access lower layer processor 15 can be processed with the communication capacity of the common bus. Moreover, there is no intention to impose a restriction of arranging the wireless frequency signal processor 33 and the antenna 34 to the same position as that of the wireless access upper layer processor 13 and the wireless access lower layer processor 15. Even when the wireless frequency signal processor 33 and the antenna 34 are arranged to a position remote from the wireless access lower layer processor 15 and the like, an object to be achieved by this invention can be achieved.

### Sixth Embodiment

In a sixth embodiment of this invention, a description is given of a second example of the apparatus configuration for realizing the first to fourth embodiments. The wireless communication system according to the sixth embodiment may be the same as any one of or a combination of the wireless communication systems according to the first to fifth embodiments except for a different point described below, and illustrations and descriptions of parts other than the different point are thus omitted. Moreover, a description of parts denoted by the same reference numerals as those for the parts of the first to fifth embodiments out of illustrated parts of the sixth embodiment is the same as the description of the parts of the first to fifth embodiments unless a different point is described below, and is thus omitted.

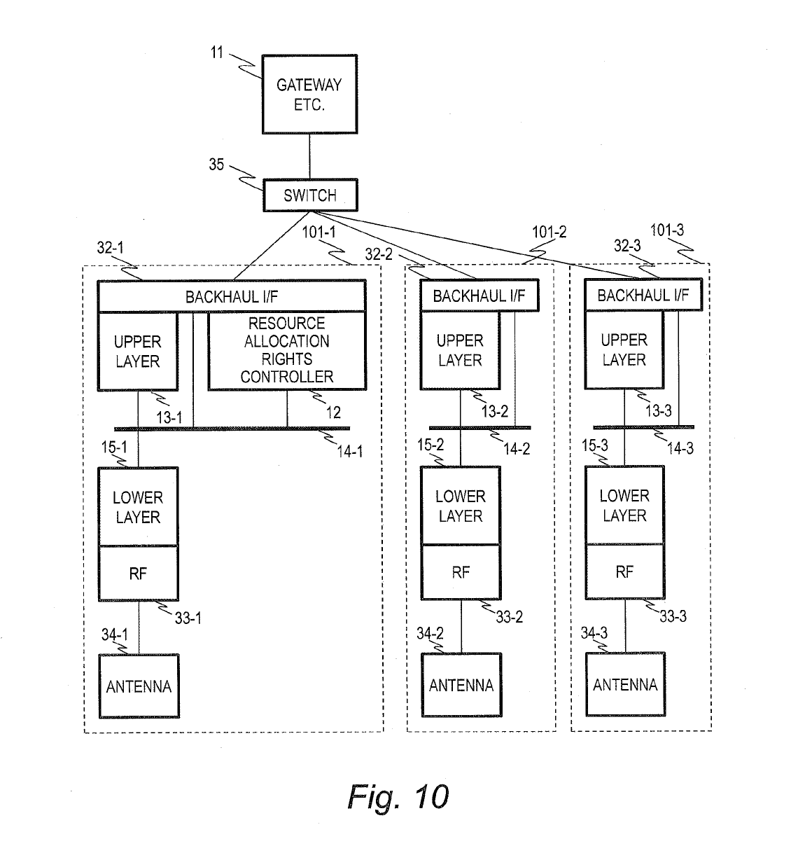

FIG. 10 is a block diagram illustrating an apparatus configuration of the communication system according to the sixth embodiment of this invention.

The apparatus configuration example illustrated in FIG. 10 is such an example that a plurality of base station apparatus 101 (such as three base station apparatus 101-1 to 101-3) exist, and each of the base station apparatus 101 manages one cell. In this example, a network switch 35 is arranged between the base station apparatus 101 and between each of the base station apparatus 101 and the core network apparatus group 11, thereby enabling mutual communication therebetween. One of the plurality of base station apparatus 101 includes the resource allocation rights controller 12, and the resource allocation rights controller 12 carries out distribution of the resource allocation rights relating to all the cells managed by the base station apparatus 101 and base station apparatus 101 therearound. It should be noted that this embodiment and the fifth embodiment may simultaneously exist in the single wireless communication system. For example, such base station apparatus 101 for managing a plurality of cells as illustrated in FIG. 9 may be added to the wireless communication system of FIG. 10, and may be coupled to the network switch 35.

Common transmission lines 14-1 to 14-3 illustrated in FIG. 10 may be the same as the common transmission line 14 illustrated in FIG. 9. The common transmission lines 14-1 to 14-3 may be collectively referred to as common transmission line 14 for the sake of common description.

It should be noted that the resource allocation rights controller 12, the wireless access upper layer processor 13 for each cell, and the wireless access lower layer processor 15 for each cell according to this embodiment may respectively be realized by dedicated logical circuits provided in the base station apparatus 101, or may respectively be realized by at least one general-purpose processor (not shown) provided in each base station apparatus 101 executing a program stored in a memory (not shown) provided in each base station apparatus 101.

A description is now given of function blocks, and a description of function blocks the same in function as those of FIG. 2 and FIG. 9 is omitted.

The network switch 35 is a so-called router, and transmits data traffic of terminals and control information on the system between each of the base station apparatus 101 and the core network apparatus group 11, and transmits the information on the inter-cell cooperation control between each of the base station apparatus 101 according to this invention described in the first and second embodiments.

The backhaul interface 32 is directly coupled to the common transmission line 14 in each of the base station apparatus 101, which is different from the fifth embodiment. A purpose of this configuration is to transmit the instruction to carry out the wireless signal processing between cells represented by Step 29 of FIG. 3 from the wireless access upper layer processor 13 of a certain base station apparatus 101 to the wireless access lower layer processor 15 of another base station apparatus 101, the allocation right waiver notification represented by Step 31 of FIG. 7 to the wireless access upper layer processor 13 of another base station apparatus 101, and the notification of the wireless signal processing result between cells represented by Step 29 of FIG. 3 from the wireless access lower layer processor 15 of a certain base station apparatus 101 to the wireless access upper layer processor 13 of another base station apparatus 101.

Moreover, when the allocation rights information notification represented by Step 23 of FIG. 3 issued by the resource allocation rights controller 12 is notified to another base station apparatus 101, the allocation rights information notification is notified via the backhaul line to the wireless access upper layer processor 13 of the other base station apparatus 101. When the allocation rights information notification is notified to the same base station apparatus 101, the allocation rights information notification is notified via the common transmission line 14 to the wireless access upper layer processor 13 in the same base station apparatus 101.

The point of this embodiment is such a point that the resource allocation rights controller 12 is arranged in one of the base station apparatus 101 so that the one of the base station apparatus 101 is set as a master of the inter-cell cooperation control according to this invention, surrounding base station apparatus 101 are set as slaves of the inter-cell cooperation control according to this invention, and the control according to this invention described in the first and second embodiments is carried out via the network switch 35. Such a configuration that the resource allocation rights controller 12 is implemented in each base station apparatus 101 and the resource allocation rights controllers 12 other than that in the base station apparatus 101 set as the master are brought into a sleep state is also included in the scope of this embodiment.

### Seventh Embodiment

In a seventh embodiment of this invention, a description is given of a third example of the apparatus configuration for realizing the first to fourth embodiments. The wireless communication system according to the seventh embodiment may be the same as any one of or a combination of the wireless communication systems according to the first to sixth embodiments except for a different point described below, and illustrations and descriptions of parts other than the different point are thus omitted. Moreover, a description of parts denoted by the same reference numerals as those for the parts of the first to sixth embodiments out of illustrated parts of the seventh embodiment is the same as the description of the parts of the first to sixth embodiments unless a different point is described below, and is thus omitted.

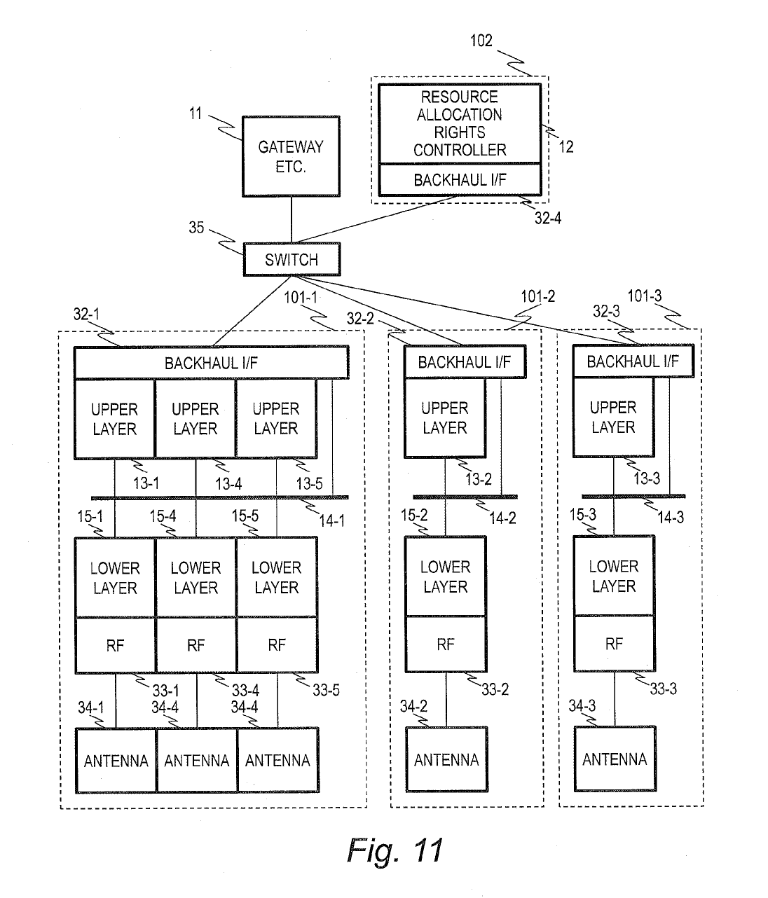

FIG. 11 is a block diagram illustrating an apparatus configuration of the communication system according to the seventh embodiment of this invention.

An apparatus configuration example illustrated in FIG. 11 is such an example that a plurality of base station apparatus 101 exist, and are coupled via the network switch 35 to the core network apparatus group 11 and a base station control apparatus 102. The base station control apparatus 102 includes the backhaul interface 32 and the resource allocation rights controller 12. The resource allocation rights controller 12 distributes resource allocation rights for all cells managed by the base station apparatus 101 coupled via the network switch 35.

Wireless access upper layer processors 13-4 and 13-5, wireless access lower layer processors 15-4 and 15-5, wireless frequency signal processors 33-4 and 33-5, and antennas 34-4 and 34-5 illustrated in FIG. 11 may be the same as the wireless access upper layer processors 13-1 to 13-3, the wireless access lower layer processors 15-1 to 15-3, the wireless frequency signal processors 33-1 to 33-3, and the antennas 34-1 to 34-3 illustrated in FIG. 9, respectively.

It should be noted that the wireless access upper layer processor 13 for each cell and the wireless access lower layer processor 15 for each cell according to this embodiment may respectively be realized by dedicated logical circuits provided in the each base station apparatus 101, or may be realized by at least one general-purpose processor (not shown) provided in the each base station apparatus 101 executing a program stored in a memory (not shown) provided in the each base station apparatus 101. Moreover, the base station control apparatus 102 may be a computer system coupled to the network switch 35, and the resource allocation rights controller 12 according to this embodiment may be realized by at least one general purpose processor (not shown) provided in the computer system executing a program stored in a memory (not shown) provided in the computer system.

A description of the communication system according to the seventh embodiment corresponds to a combination of descriptions of FIGS. 9 and 10, and a detailed description thereof is therefore omitted herein.

A point of this embodiment is such a point that the resource allocation rights controller 12 is arranged outside the base station apparatus 101 so that the resource allocation rights controller 12 carries out control according to this invention described in the first and second embodiments for each of the base station apparatus 101 via the network switch 35.

### Eighth Embodiment

In an eighth embodiment of this invention, a description is given of a fourth example of the apparatus configuration for realizing the first to fourth embodiments. The wireless communication system according to the eighth embodiment may be the same as any one of or a combination of the wireless communication systems according to the first to seventh embodiments except for a different point described below, and illustrations and descriptions of parts other than the different point are thus omitted. Moreover, a description of parts denoted by the same reference numerals as those for the parts of the first to seventh embodiments out of illustrated parts of the eighth embodiment is the same as the description of the parts of the first to seventh embodiments unless a different point is described below, and is thus omitted.

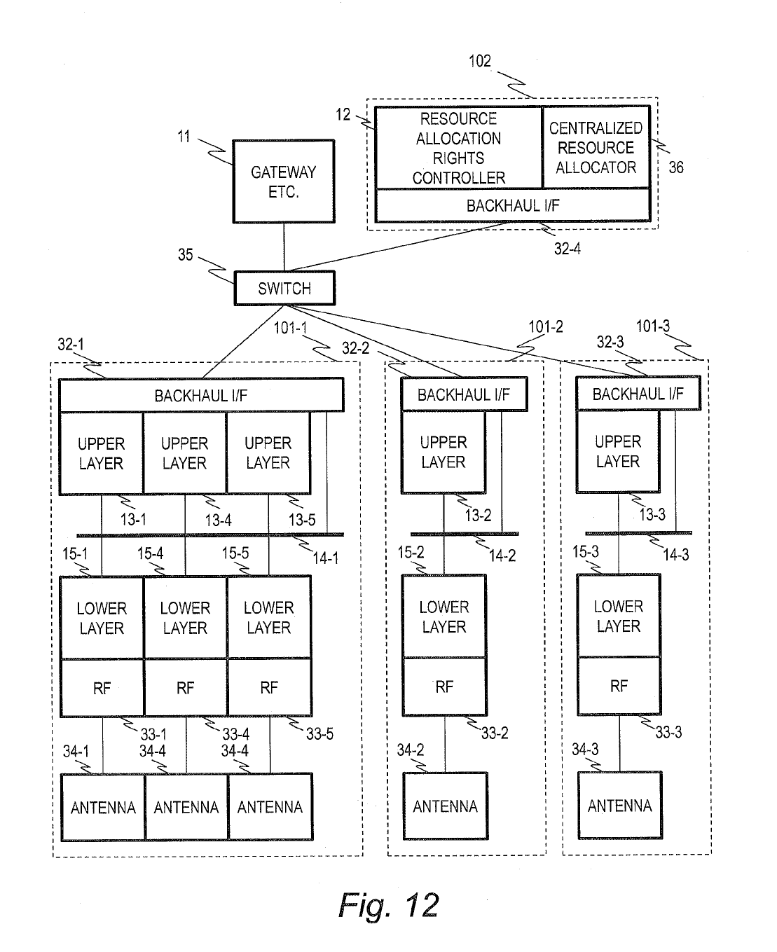

FIG. 12 is a block diagram illustrating an apparatus configuration of the communication system according to the eighth embodiment of this invention.

In this embodiment, a part or all of the wireless resource allocation function held by each cell is centralized. This embodiment is the same as the seventh embodiment except for the centralization of the wireless resource allocation function.

It should be noted that the wireless access upper layer processor 13 for each cell and the wireless access lower layer processor 15 for each cell according to this embodiment may respectively be realized by dedicated logical circuits provided in the each base station apparatus 101, or may be realized by at least one general-purpose processor (not shown) provided in the each base station apparatus 101 executing a program stored in a memory (not shown) provided in the each base station apparatus 101. Moreover, the base station control apparatus 102 may be a computer system coupled to the network switch 35, and the resource allocation rights controller 12 and a centralized resource allocator 36 according to this embodiment may be realized by at least one general purpose processor (not shown) provided in the computer system executing a program stored in a memory (not shown) provided in the computer system.

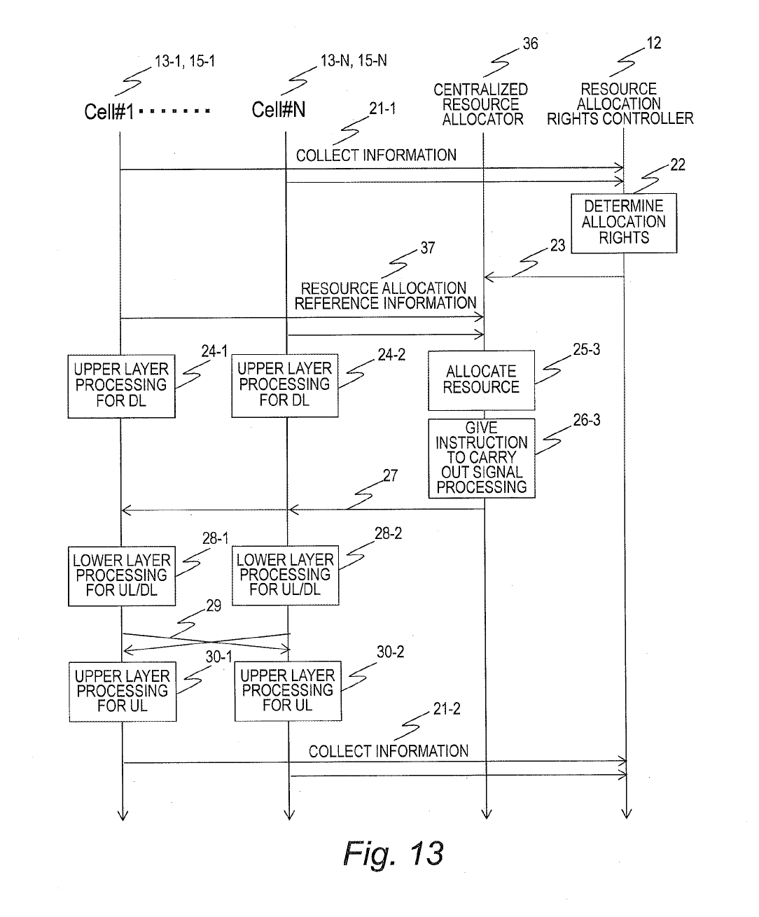

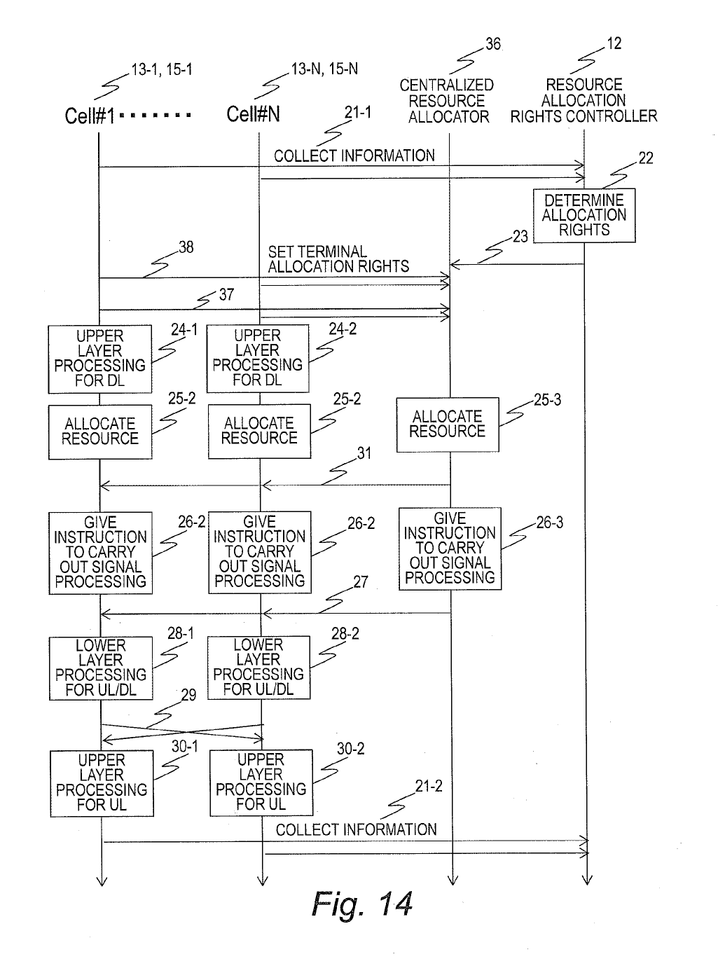

Specifically, in this embodiment, as illustrated in FIG. 12, a part or all of the wireless resource allocation function held by the wireless access upper layer processor 13 for the each cell is centralized to the centralized resource allocator 36 of the base station control apparatus 102. Referring to FIGS. 13 and 14, a description is given of an operation carried out when the centralized resource allocator 36 is introduced.

FIG. 13 is a sequence diagram illustrating a first example of processing to be carried out in the wireless communication system according to the eighth embodiment of this invention.

Specifically, FIG. 13 illustrates an operation sequence carried out when the entire wireless resource allocation function is centralized to the centralized resource allocator 36.

The centralized resource allocator 36 collects the information referred to by each cell for the wireless resource allocation in order to centrally carry out the wireless resource allocation carried out by the wireless access upper layer processor 13 for each cell in the first and second embodiments (Step 37). The information collected in this step includes wireless communication quality information on each terminal, channel state information (CSI), and a remaining amount of a queue of each terminal. The centralized resource allocator 36 determines which wireless resource of which cell is allocated to a terminal belonging to each cell based on the information collected in Step 37. On this occasion, the centralized resource allocator 36 refers to the resource allocation right distribution for each cell generated by the resource allocation rights controller 12 included in the base station control apparatus 102, which has been described in the first embodiment. The instruction to carry out the wireless signal processing (Step 26) to each of the cells is also given by the centralized resource allocator 36. The rest of the operation sequence is the same as the operation sequence of FIG. 3.

FIG. 14 is a sequence diagram illustrating a second example of processing to be carried out in the wireless communication system according to the eighth embodiment of this invention.

Specifically, FIG. 14 illustrates an operation sequence carried out when a part of the wireless resource allocation function is centralized to the centralized resource allocator 36, but the wireless resource allocation function is also left to the wireless access upper layer processor 13 for the each cell. This example is approximately the same as that of FIG. 13, but is different in that both of each of the cells and the centralized resource allocator 36 are in charge of the wireless resource allocation on a level of the terminal.

For such a terminal having the difference between the measured DL received electric power for the assigned cell and the measured DL received electric power for the neighboring cell within the threshold as shown in FIG. 4 of the first embodiment out of the terminals belonging to the each cell, namely, a terminal located on a cell boundary, the centralized resource allocator 36 carries out the wireless resource allocation, and each cell does not carry out the wireless resource allocation. Each cell carries out the wireless resource allocation for only terminals which are not located at the cell boundary.

The each cell refers to the value reported in such a format as shown in FIG. 4 from a terminal, and determines whether the terminal is located on the cell boundary or not. When the each cell determines that the terminal is located on the boundary, the each cell requests the centralized resource allocator 36 to carry out the wireless resource allocation for the terminal (Step 38). On this occasion, the each cell also provides the centralized resource allocator 36 with information indicating to which cell the terminal belongs, and indicating the boundary to which cell the terminal is located on.

The reference information on the resource allocation provided in Step 37 is information on the terminal for which the each cell requests the centralized resource allocator 36 to carry out the wireless resource allocation in Step 38, and is transmitted in the same manner as in FIG. 13. There is such a difference that the information on all the terminals belonging to the cell is transmitted in Step 37 in the example of FIG. 13, and the information only on a part of the terminals is transmitted in the example of FIG. 14.

The resource allocation waiver notification of Step 31 is notified in the form of FIG. 8A or 8B from the centralized resource allocator 36 to the corresponding cell. On this occasion, the wireless communication system defines a cell ID representing the centralized resource allocator 36, and the value is applied as the transmission source ID 801 or 811.

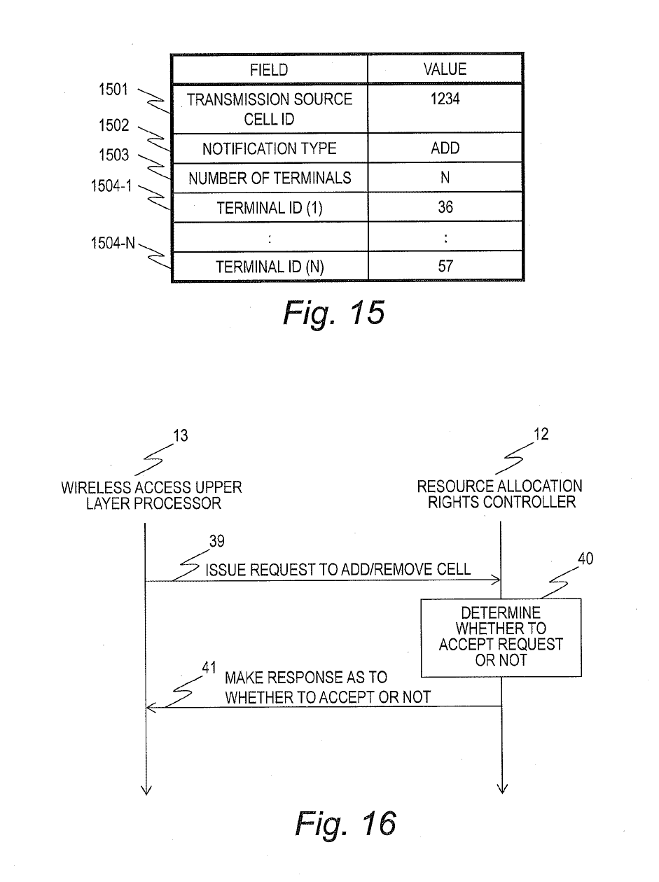

FIG. 15 is an explanatory diagram of an example of a terminal allocation right setting notification 38 notified from each cell to the centralized resource allocator 36 according to the eighth embodiment of this invention.

The notification is generated by the wireless access upper layer processor 13 for the each cell. Notified contents include a transmission source cell ID 1501, a notification type 1502, and a list of terminals relating to the notification. The notification type includes ADD and REMOVE ADD represents that the centralized resource allocator 36 carries out the wireless resource allocation for a terminal in the list, and REMOVE represents that the wireless access upper layer processor 13 of a cell of the transmission source of the notification carries out the wireless resource allocation for a terminal in the list. The list of terminals includes a number of terminals 1503 representing the number of terminals and a list of terminal IDs 1504 each for identifying a terminal to which the notified type (ADD or REMOVE) is applied. For example, when the value of the number of terminals 1503 is N, the list of terminals includes a terminal ID (1) 1504-1 to a terminal ID (N) 1504-N.

A processing load on the wireless access upper layer processor 13 can be reduced in this manner by the centralized resource allocator 36 carrying out a part or all of the resource allocation.

It should be noted that this invention is not limited to the above-mentioned embodiments, and can include various modification examples. Moreover, the above-mentioned embodiments have been described in detail for the sake of a description easy to understand, and this invention is not necessarily limited to a configuration including all the components described above. Moreover, a part of a configuration of a certain embodiment can be replaced by a configuration of another embodiment, and, to a configuration of a certain embodiment, a configuration of another embodiment can be added. Moreover, another component may be added to, be removed from, or replace a part of the configuration of each of the embodiments.

Moreover, the respective configurations, the functions, the processors, the processing means, and the like in all or part may also be realized as hardware by designing with integrated circuits. Moreover, the respective configurations, functions, and the like may also be realized as software by a processor interpreting and executing programs realizing the respective functions. Information such as programs, tables, and files for realizing the respective functions can be stored in storage devices such as a non-volatile semiconductor memory, a hard disk drive, and a solid state drive (SSD), and a non-transitory computer-readable data storage medium such as an IC card, an SD card, and a DVD.

Control lines and information lines considered to be necessary for describing the embodiments are illustrated in the drawings, and all control lines and information lines included in an actual product to which this invention is applied are not always illustrated. It may also be considered that almost all configurations are actually mutually coupled to each other.

What is claimed is:

1. A base station apparatus for communicating to/from a terminal, comprising:
a first wireless access upper layer processor corresponding to a first cell for wireless communication; and
a first wireless access lower layer processor corresponding to the first cell, wherein:
the first wireless access upper layer processor is configured to:
hold allocation rights information representing that the first cell has a right to allocate a part of a wireless resource owned by the first cell to a terminal belonging to the first cell, and does not have a right to allocate a remaining part of the wireless resource;
allocate the part of the wireless resource which the first cell has the right to allocate out of the wireless resource owned by the first cell to the terminal belonging to the first cell; and
instruct the first wireless access lower layer processor to carry out wireless signal processing for the communication to/from the terminal by using the allocated part of the wireless resource; and
the first wireless access lower layer processor is configured to:
carry out, in accordance with the instruction to carry out the wireless signal processing, the wireless signal processing for the communication to/from the terminal by using the allocated part of the wireless resource; and
notify the first wireless access upper layer processor of a result of the wireless signal processing which has been carried out.

2. The base station apparatus according to claim 1, further comprising:
a second wireless access upper layer processor corresponding to a second cell for wireless communication; and
a second wireless access lower layer processor corresponding to the second cell, wherein:
the allocation rights information includes information representing that the first cell has a right to allocate a part of a wireless resource owned by the second cell to the terminal belonging to the first cell;
the first wireless access upper layer processor is further configured to:
allocate the part of the wireless resource which the first cell has the right to allocate out of the wireless resource owned by the second cell to the terminal belonging to the first cell; and
instruct the second wireless access lower layer processor to carry out wireless signal processing for the communication to/from the terminal by using the allocated part of the wireless resource; and
the second wireless access lower layer processor is configured to:
carry out, in accordance with the instruction to carry out the wireless signal processing, the wireless signal processing for the communication to/from the terminal by using the allocated part of the wireless resource; and
notify the first wireless access upper layer processor of a result of the wireless signal processing which has been carried out.

3. The base station apparatus according to claim 2, wherein:
when the first wireless access upper layer processor does not allocate the part of the wireless resource of the second cell which the first cell has the right to allocate to the terminal belonging to the first cell, the first wireless access upper layer processor notifies the second wireless access upper layer processor of information for identifying the part of the wireless resource of the second cell which is not allocated; and
the second wireless access upper layer processor allocates the identified part of the wireless resource of the second cell to a terminal belonging to the second cell.

4. The base station apparatus according to claim 1, wherein:
the allocation rights information includes information representing that the first cell has a right to allocate a part of a wireless resource owned by a second cell managed by another base station apparatus to the terminal belonging to the first cell;
the first wireless access upper layer processor is further configured to:
allocate the part of the wireless resource for which the first cell has the right to allocate out of the wireless resource owned by the second cell to the terminal belonging to the first cell; and
instruct the another base station apparatus to carry out wireless signal processing for the communication to/from the terminal by using the allocated part of the wireless resource; and
the first wireless access lower layer processor is further configured to:
carry out, when the first wireless access lower layer processor receives from the another station the instruction to carry out the wireless signal processing for the communication to/from the terminal by using the part of the wireless resource for which the first cell does not have the right to allocate out of the resource owned by the first cell, in accordance with the instruction to carry out the wireless signal processing, the wireless signal processing by using the allocated part of the wireless resource for the communication to/from the terminal; and
notify the another base station apparatus of a result of the wireless signal processing which has been carried out.

5. The base station apparatus according to claim 4, wherein the first wireless access upper layer processor is further configured to:
notify, when the first wireless access upper layer processor does not allocate the part of the wireless resource of the second cell which the first cell has the right to allocate to the terminal belonging to the first cell, the another base station apparatus of information for identifying the part of the wireless resource of the second cell which is not allocated; and
allocate, when the first wireless access upper layer processor receives information for identifying a part of the wireless resource which is not allocated to a terminal belonging to another cell out of the part of the wireless resource which the first cell does not have the right to allocate, the identified part of the wireless resource to the terminal belonging to the first cell.

6. The base station apparatus according to claim 1, further comprising a resource allocation rights controller for determining, in order that the first cell has a right to allocate a part of the wireless resource owned by the first cell, and a cell other than the first cell has a right to allocate a remaining part of the wireless resource owned by the first cell, a distribution of the rights to allocate, and notifying the first wireless access upper layer processor of the determined distribution of the rights to allocate as the allocation rights information.

7. A wireless communication system, comprising:
a plurality of wireless access upper layer processors each corresponding to each of a plurality of cells for wireless communication;
a plurality of wireless access lower layer processors each corresponding to the each of the plurality of cells; and
a resource allocation rights controller, wherein:
the resource allocation rights controller determines a cell having a right to allocate a wireless resource owned by the each of the plurality of cells to a terminal belonging to the each of the plurality of cells;
each of the plurality of wireless access upper layer processors corresponding to the each of the plurality of cells is configured to:
allocate the wireless resource which the each of the plurality of cells has the right to allocate to the terminal belonging to the each of the plurality of cells; and
instruct one of the plurality of wireless access lower layer processors corresponding to the cell owning the allocated wireless resource to carry out wireless signal processing for the communication to/from the terminal by using the allocated wireless resource; and
each of the plurality of wireless access lower layer processors corresponding to the each of the plurality of cells is configured to:
carry out, in accordance with the instruction of the wireless signal processing, the wireless signal processing for the communication to/from the terminal by using the allocated wireless resource; and
notify the each of the plurality of wireless access upper layer processors which has given the instruction to carry out the wireless signal processing of a result of the wireless signal processing which has been carried out.

8. The wireless communication system according to claim 7, wherein:
the plurality of cells include a first cell and a second cell;
the plurality of wireless access upper layer processors include a first wireless access upper layer processor corresponding to the first cell and a second wireless access upper layer processor corresponding to the second cell;
the plurality of wireless access lower layer processors include a first wireless access lower layer processor corresponding to the first cell and a second wireless access lower layer processor corresponding to the second cell;
when the first wireless access upper layer processor does not allocate the wireless resource of the second cell which the first cell has the right to allocate to a terminal belonging to the first cell, the first wireless access upper layer processor notifies the second wireless access upper layer processor of information for identifying the wireless resource of the second cell which is not allocated; and
the second wireless access upper layer processor allocates the identified wireless resource of the second cell to a terminal belonging to the second cell.

9. The wireless communication system according to claim 8, wherein:
each of the plurality of wireless access upper layer processors transmits an electric power measurement result for a wireless signal by a plurality of terminals belonging to each of the plurality of cells to the resource allocation rights controller; and
the resource allocation rights controller determines, based on a ratio between a number of terminals estimated, by using the electric power measurement result, to exist close to a boundary between the first cell and cells other than the first cell out of the terminals belonging to cells other than the first cell, and a total number of the terminals belonging to the first cell, a ratio for distributing a right to allocate the wireless resource owned by the first cell to the first cell and the cells other than the first cell, and determines cells having the right to allocate the wireless resource owned by the first cell in accordance with the determined ratio.

10. The wireless communication system according to claim 9, wherein one of the first wireless access upper layer processor and the resource allocation rights controller estimates that, out of the terminals belonging to a cell other than the first cell, a terminal equal to or lower than a predetermined value in a difference between an electric power measurement value of a wireless signal from the cell other than the first cell and an electric power measurement value of a wireless signal from the first cell is arranged close to a boundary between the first cell and the cell other than the first cell.

11. A wireless communication system, comprising:
a plurality of wireless access upper layer processors each corresponding to each of a plurality of cells for wireless communication;
a plurality of wireless access lower layer processors each corresponding to the each of the plurality of cells;
a resource allocation rights controller; and
a resource allocator, wherein:
the resource allocation rights controller determines a cell having a right to allocate a wireless resource owned by the each of the plurality of cells to a terminal belonging to the each of the plurality of cells;
the resource allocator allocates the wireless resource which the each of the plurality of cells has the right to allocate to the terminal belonging to the each of the plurality of cells;
each of the plurality of wireless access upper layer processors corresponding to the each of the plurality of cells instructs one of the plurality of wireless access lower layer processors corresponding to the cell owning the allocated wireless resource to carry out wireless signal processing for the communication to/from the terminal by using the allocated wireless resource; and
each of the plurality of wireless access lower layer processors corresponding to the each of the plurality of cells is configured to:
carry out, in accordance with the instruction of the wireless signal processing, the wireless signal processing for the communication to/from the terminal by using the allocated wireless resource; and
notify the each of the plurality of first wireless access upper layer processors which has given the instruction to carry out the wireless signal processing of a result of the wireless signal processing which has been carried out.

12. The wireless communication system according to claim 11, wherein:
the plurality of cells include a first cell;
the each of the plurality of wireless access upper layer processors transmits an electric power measurement result for a wireless signal by a plurality of terminals belonging to the each of the plurality of cells to the resource allocation rights controller;
the resource allocator allocates, based on the electric power measurement result, the wireless resource for which the each of the plurality of cells has a right to allocate to, out of the terminals belonging to cells other than the first cell, a terminal estimated to be arranged close to a border between the first cell and the cells other than the first cell; and
the each of the plurality of wireless access upper layer processors corresponding to the each of the plurality of cells allocates the wireless resource for which the each of the plurality of cells has the right to allocate to, out of the terminals belonging to the each of the plurality of cells, a terminal to which the resource allocator has not allocated the wireless resource.
